(19) United States
(12) Patent Application Publication
(10) Pub. No.: US 2026/0330658 A1
(43) Pub. Date: Oct. 22, 2026

(54) GENERATIVE TRAJECTORY MODELS

(71) Applicants: HONDA MOTOR CO., LTD., Tokyo (JP); Northwestern University, Evanston, IL (US)

(72) Inventors: Todd David MURPHEY, Evanston, IL (US); Muchen SUN, Chicago, IL (US); Peter F. TRAUTMAN, Pebble Beach, CA (US)

(21) Appl. No.: 19/458,555

(22) Filed: Jan. 23, 2026

Related U.S. Application Data
(60) Provisional application No. 63/783,041, filed on Apr. 3, 2025.

(51) Int. Cl. G06T 7/277; G06N 3/0455; G06N 3/084

(52) U.S. Cl. CPC G06T 7/277; G06N 3/0455; G06N 3/084; G06T 2207/20081; G06T 2207/20084; G06T 2207/30241

(57) ABSTRACT

Generating a generative trajectory model may include generating a non-interactive model that calculates probability distributions of predicted future trajectories for a first agent and a second agent based on a first portion of measured trajectory for each agent. The non-interactive model may assume that each agent operates independently of one another. Generating a generative trajectory model may include generating a game-theoretic model that evaluates the probability distributions of predicted future trajectories based on a parameterized cost function and calculates a set of updated probability distributions of predicted future trajectories based on the evaluation and training a generative trajectory model that combines the non-interactive model and the game-theoretic model by calculating a training loss based on the set of updated probability distributions and a second portion of the measured trajectory for each agent and optimizing the parameterized cost function by minimizing the training loss through gradient descent.

### CROSS-REFERENCE TO RELATED APPLICATIONS

This application claims the benefit of U.S. Provisional Patent Application, Ser. No. 63/783,041 (Attorney Docket No. HRA-57553) entitled “INVERSE MIXED STRATEGY GAMES WITH GENERATIVE TRAJECTORY MODELS”, filed on Apr. 3, 2025; the entirety of the above-noted application(s) is incorporated by reference herein.

### TECHNICAL FIELD

The present disclosure relates to apparatuses and methods for generating a generative trajectory model for multi-agent environments in robotics and autonomous systems using inverse game-theoretic models or a mixed strategy game model.

### BACKGROUND

It is increasingly important for robot agents to interact with humans without causing discomfort or compromising task efficiency. As an example, in scenarios of social navigation and autonomous driving, a robot agent may need to reason over the influence of its actions on other agents' decision-making. Thus, there is a need for a framework to replace conventional single-agent planning models by robustly inferring multi-agent objectives from noisy data and adapting to real-time observations.

### BRIEF DESCRIPTION

According to one aspect, a system for generating a generative trajectory model may include a memory and a processor. The memory may store one or more instructions. The processor may execute one or more of the instructions stored on the memory to perform one or more acts, actions, and/or steps. The processor may perform generating a non-interactive model that calculates probability distributions of predicted future trajectories for a first agent and a second agent based on a first portion of measured trajectory for each agent. The non-interactive model may assume that each agent operates independently of one another. The processor may perform generating a game-theoretic model that evaluates the probability distributions of predicted future trajectories based on a parameterized cost function and calculates a set of updated probability distributions of predicted future trajectories based on the evaluation. The processor may perform training a generative trajectory model that combines the non-interactive model and the game-theoretic model by calculating a training loss based on the set of updated probability distributions and a second portion of the measured trajectory for each agent and optimizing the parameterized cost function by minimizing the training loss through gradient descent.

The non-interactive model may utilize a conditional variational autoencoder (CVAE) to generate the probability distributions of predicted future trajectories. The parameterized cost function may include a deep neural network trained to represent an inter-agent interaction between the first agent and the second agent. The game-theoretic model may use a Bayesian recursive Nash equilibrium to calculate the set of updated probability distributions of predicted future trajectories. The Bayesian Recursive Nash Equilibrium may iteratively update sample weights of the predicted future trajectories to minimize expected costs between the first and second agents. The first agent may be an ego-agent and the second agent may be an adjacent agent operating adjacent to the ego-agent.

The processor may perform collecting real-time trajectories for the ego-agent and the adjacent agent from a sensor of the ego-agent. The processor may perform calculating, by the non-interactive model, probability distributions of predicted future trajectories for the ego-agent and the adjacent agent based on the collected real-time trajectories. The processor may perform calculating, by the game-theoretic model, a set of updated probability distributions of predicted future trajectory for the ego-agent by evaluating the probability distributions of predicted future trajectories for the ego-agent and the adjacent agent based on the parameterized cost function. The processor may perform performing a path planning to generate a future trajectory for the ego-agent based on the set of updated probability distributions of predicted future trajectory. The processor may perform controlling the ego-agent to drive to a destination based on the generated future trajectory.

According to one aspect, a computer-implemented method for generating a generative trajectory model may include generating a non-interactive model that calculates probability distributions of predicted future trajectories for a first agent and a second agent based on a first portion of measured trajectory for each agent. The non-interactive model may assume that each agent operates independently of one another. The computer-implemented method for generating a generative trajectory model may include generating a game-theoretic model that evaluates the probability distributions of predicted future trajectories based on a parameterized cost function and calculates a set of updated probability distributions of predicted future trajectories based on the evaluation. The computer-implemented method for generating a generative trajectory model may include training a generative trajectory model that combines the non-interactive model and the game-theoretic model by calculating a training loss based on the set of updated probability distributions and a second portion of the measured trajectory for each agent and optimizing the parameterized cost function by minimizing the training loss through gradient descent.

The non-interactive model may utilize a conditional variational autoencoder (CVAE) to generate the probability distributions of predicted future trajectories. The parameterized cost function may include a deep neural network trained to represent an inter-agent interaction between the first agent and the second agent. The game-theoretic model may use a Bayesian recursive Nash equilibrium to calculate the set of updated probability distributions of predicted future trajectories. The Bayesian Recursive Nash Equilibrium may iteratively update sample weights of the predicted future trajectories to minimize expected costs between the first and second agents. The first agent may be an ego-agent and the second agent may be an adjacent agent operating adjacent to the ego-agent.

The computer-implemented method may include collecting real-time trajectories for the ego-agent and the adjacent agent from a sensor of the ego-agent. The computer-implemented method may include calculating, by the non-interactive model, probability distributions of predicted future trajectories for the ego-agent and the adjacent agent based on the collected real-time trajectories. The computer-implemented method may include calculating, by the game-theoretic model, a set of updated probability distributions of predicted future trajectory for the ego-agent by evaluating the probability distributions of predicted future trajectories for the ego-agent and the adjacent agent based on the parameterized cost function. The computer-implemented method may include performing a path planning to generate a future trajectory for the ego-agent based on the set of updated probability distributions of predicted future trajectory. The computer-implemented method may include controlling the ego-agent to drive to a destination based on the generated future trajectory.

According to one aspect, a non-transitory computer readable storage medium storing instructions that when executed by a computer having a processor to perform a method for generating a generative trajectory model. The method for generating a generative trajectory model may include generating a non-interactive model that calculates probability distributions of predicted future trajectories for a first agent and a second agent based on a first portion of measured trajectory for each agent. The non-interactive model may assume that each agent operates independently of one another. The method for generating a generative trajectory model may include generating a game-theoretic model that evaluates the probability distributions of predicted future trajectories based on a parameterized cost function and calculates a set of updated probability distributions of predicted future trajectories based on the evaluation. The method for generating a generative trajectory model may include training a generative trajectory model that combines the non-interactive model and the game-theoretic model by calculating a training loss based on the set of updated probability distributions and a second portion of the measured trajectory for each agent and optimizing the parameterized cost function by minimizing the training loss through gradient descent.

The non-interactive model may utilize a conditional variational autoencoder (CVAE) to generate the probability distributions of predicted future trajectories. The parameterized cost function may include a deep neural network trained to represent an inter-agent interaction between the first agent and the second agent. The game-theoretic model may use a Bayesian recursive Nash equilibrium to calculate the set of updated probability distributions of predicted future trajectories. The Bayesian Recursive Nash Equilibrium may iteratively update sample weights of the predicted future trajectories to minimize expected costs between the first and second agents.

The method for generating a generative trajectory model may include collecting real-time trajectories for an ego-agent and an adjacent agent from a sensor of the ego-agent. The method for generating a generative trajectory model may include calculating, by the non-interactive model, probability distributions of predicted future trajectories for the ego-agent and the adjacent agent based on the collected real-time trajectories. The method for generating a generative trajectory model may include calculating, by the game-theoretic model, a set of updated probability distributions of predicted future trajectory for the ego-agent by evaluating the probability distributions of predicted future trajectories for the ego-agent and the adjacent agent based on the parameterized cost function. The method for generating a generative trajectory model may include performing a path planning to generate a future trajectory for the ego-agent based on the set of updated probability distributions of predicted future trajectory. The method for generating a generative trajectory model may include controlling the ego-agent to drive to a destination based on the generated future trajectory.

### BRIEF DESCRIPTION OF THE DRAWINGS

FIG. 1 is an illustration of a block diagram of an exemplary system for generating a generative trajectory model, according to one aspect.

FIG. 2 is an illustration of an exemplary schematic representation of an algorithm of training a generative trajectory model, according to one aspect.

FIG. 3A is an illustration of exemplary measured trajectories of multi-agents, according to one aspect.

FIG. 3B is an illustration of exemplary probability distributions of predicted future trajectories of multi-agents before solving the inverse game equation, according to one aspect.

FIG. 3C is an illustration of exemplary updated probability distributions of predicted future trajectories of multi-agents after solving the inverse game equation, according to one aspect.

FIG. 4 is an illustration of an exemplary schematic representation of algorithm of executing the generative trajectory model, according to one aspect.

FIG. 5 is an illustration of an example computing environment where one or more of the provisions set forth herein are implemented, according to one aspect.

FIG. 6 is an illustration of an example computer-readable medium or computer-readable device including processor-executable instructions configured to embody one or more of the provisions set forth herein, according to one aspect.

### DETAILED DESCRIPTION

The following includes definitions of selected terms employed herein. The definitions include various examples and/or forms of components that fall within the scope of a term and that may be used for implementation. The examples are not intended to be limiting. Further, one having ordinary skill in the art will appreciate that the components discussed herein, may be combined, omitted, or organized with other components or organized into different architectures.

A “processor”, as used herein, processes signals and performs general computing and arithmetic functions. Signals processed by the processor may include digital signals, data signals, computer instructions, processor instructions, messages, a bit, a bit stream, or other means that may be received, transmitted, and/or detected. Generally, the processor may be a variety of various processors including multiple single and multicore processors and co-processors and other multiple single and multicore processor and co-processor architectures. The processor may include various modules to execute various functions.

A “memory”, as used herein, may include volatile memory and/or non-volatile memory. Non-volatile memory may include, for example, ROM (read only memory), PROM (programmable read only memory), EPROM (erasable PROM), and EEPROM (electrically erasable PROM). Volatile memory may include, for example, RAM (random access memory), synchronous RAM (SRAM), dynamic RAM (DRAM), synchronous DRAM (SDRAM), double data rate SDRAM (DDRSDRAM), and direct RAM bus RAM (DRRAM). The memory may store an operating system that controls or allocates resources of a computing device.

A “disk” or “drive”, as used herein, may be a magnetic disk drive, a solid-state disk drive, a floppy disk drive, a tape drive, a Zip drive, a flash memory card, and/or a memory stick. Furthermore, the disk may be a CD-ROM (compact disc ROM), a CD recordable drive (CD-R drive), a CD rewritable drive (CD-RW drive), and/or a digital video ROM drive (DVD-ROM). The disk may store an operating system that controls or allocates resources of a computing device.

An “algorithm”, as used herein, may be one or more acts, actions, steps, calculations, etc. implemented as a computer-implemented method using one or more physical devices, such as computing device, a processor, a memory, a storage drive, etc.

A “bus”, as used herein, refers to an interconnected architecture that is operably connected to other computer components inside a computer or between computers. The bus may transfer data between the computer components. The bus may be a memory bus, a memory controller, a peripheral bus, an external bus, a crossbar switch, and/or a local bus, among others. The bus may also refer to a vehicle bus that interconnects components inside a vehicle using protocols such as Media Oriented Systems Transport (MOST), Controller Area Network (CAN), Local Interconnect Network (LIN), among others.

A “controller”, as used herein, may be a device implemented in hardware, firmware, software, or a combination thereof. A controller may include one or more CPUs (e.g., a central processing unit including one or more “processors”), a “memory”, a “storage drive”, a “bus”, and one or more programmable input/output (I/O) peripherals.

A “database” or “dataset”, as used herein, may refer to a table, a set of tables, and a set of data stores (e.g., disks) and/or methods for accessing and/or manipulating those data stores.

An “operable connection”, or a connection by which entities are “operably connected”, is one in which signals, physical communications, and/or logical communications may be sent and/or received. An operable connection may include a wireless interface, a physical interface, a data interface, and/or an electrical interface.

A “computer communication”, as used herein, refers to a communication between two or more computing devices (e.g., computer, personal digital assistant, cellular telephone, network device) and may be, for example, a network transfer, a file transfer, an applet transfer, an email, a hypertext transfer protocol (HTTP) transfer, and so on. A computer communication may occur across, for example, a wireless system (e.g., IEEE 802.11), an Ethernet system (e.g., IEEE 802.3), a token ring system (e.g., IEEE 802.5), a local area network (LAN), a wide area network (WAN), a point-to-point system, a circuit switching system, a packet switching system, among others.

A “vehicle”, as used herein, refers to any moving vehicle that is capable of carrying one or more human occupants and is powered by any form of energy. The term “vehicle” includes cars, trucks, vans, minivans, SUVs, motorcycles, scooters, boats, personal watercraft, and aircraft. In some scenarios, a motor vehicle includes one or more engines. Further, the term “vehicle” may refer to an electric vehicle (EV) that is powered entirely or partially by one or more electric motors powered by an electric battery. The EV may include battery electric vehicles (BEV) and plug-in hybrid electric vehicles (PHEV). Additionally, the term “vehicle” may refer to an autonomous vehicle and/or self-driving vehicle powered by any form of energy. The autonomous vehicle may or may not carry one or more human occupants.

A “vehicle system”, as used herein, may be any automatic or manual systems that may be used to enhance the vehicle, and/or driving. Exemplary vehicle systems include an autonomous driving system, an electronic stability control system, an anti-lock brake system, a brake assist system, an automatic brake prefill system, a low speed follow system, a cruise control system, a collision warning system, a collision mitigation braking system, an auto cruise control system, a lane departure warning system, a blind spot indicator system, a lane keep assist system, a navigation system, a transmission system, brake pedal systems, an electronic power steering system, visual devices (e.g., camera systems, proximity sensor systems), a climate control system, an electronic pretensioning system, a monitoring system, a passenger detection system, a vehicle suspension system, a vehicle seat configuration system, a vehicle cabin lighting system, an audio system, a sensory system, among others.

A “robot”, as used herein, may be a machine, such as one programmable by a computer, and capable of carrying out a complex series of actions automatically. A robot may be guided by an external control device or the control may be embedded within a controller. It will be appreciated that a robot may be designed to perform a task with no regard to appearance. Therefore, a ‘robot’ may include a machine which does not necessarily resemble a human, including a vehicle, a device, a flying robot, a manipulator, a robotic arm, etc.

A “robot system”, as used herein, may be any automatic or manual systems that may be used to enhance robot performance. Exemplary robot systems include a motor system, an autonomous driving system, an electronic stability control system, an anti-lock brake system, a brake assist system, an automatic brake prefill system, a low speed follow system, a cruise control system, a collision warning system, a collision mitigation braking system, an auto cruise control system, a lane departure warning system, a blind spot indicator system, a lane keep assist system, a navigation system, a transmission system, brake pedal systems, an electronic power steering system, visual devices (e.g., camera systems, proximity sensor systems), a climate control system, an electronic pretensioning system, a monitoring system, a passenger detection system, a suspension system, an audio system, a sensory system, among others.

An “agent”, as used herein, may be a machine that moves through or manipulates an environment. Exemplary agents may include robots, vehicles, or other self-propelled machines. The agent may be autonomously, semi-autonomously, or manually operated.

Game-theoretic models are effective tools for modeling multi-agent interactions, especially when robots need to coordinate with humans. However, applying these models may require inferring their specifications from observed behaviors. This may be a challenging task known as the inverse game problem. Existing inverse game approaches often struggle to account for behavioral uncertainty and measurement noise, and leverage both offline and online data. To address these limitations, an inverse game method is provided herein that integrates a generative trajectory model into a differentiable mixed-strategy game framework. By representing the mixed strategy with a conditional variational autoencoder (CVAE), the systems and methods for generating a generative trajectory model may provide the benefit or advantage of being able to infer high-dimensional, multi-modal behavior distributions from noisy measurements while adapting in real-time to new observations.

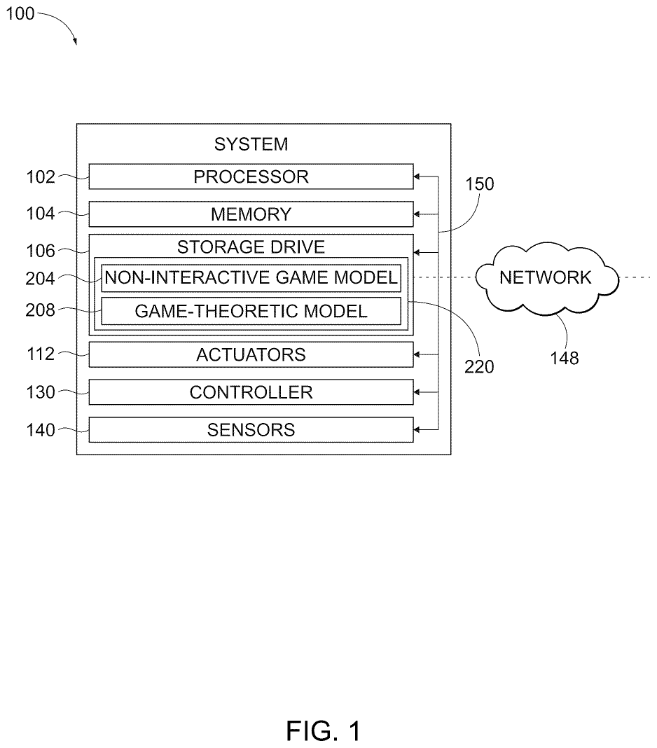

FIG. 1 is an illustration of a block diagram of an exemplary system 100 for generating a generative trajectory model, according to one aspect. The system 100 for generating the generative trajectory model may include a processor 102, a memory 104, and a storage drive 106. The storage drive 106 may store a generative trajectory model 220 including a non-interactive model 204 and a game-theoretic model 208. Additionally, the system 100 for generating the generative trajectory model may include a controller 130, sensors 140, and a bus 150. Respective components (e.g., the processor 102, the memory 104, the storage drive 106, the controller 130, and the sensors 140, etc.) of the system 100 for generating the generative trajectory model may be operably coupled or in computer communication with one another via the bus 150 or other communication pathway.

One or more of the non-interactive model 204, the game-theoretic model 208, and the generative trajectory model 220 may be implemented via the processor 102, the memory 104, the storage drive 106, etc. In other words, any actions, calculations, or determinations made based on the non-interactive model 204, the game-theoretic model 208, the generative trajectory model 220 may be performed by the processor 102, the memory 104, and/or stored on the storage drive 106. In this way, the system 100 for generating the generative trajectory model may be implemented on an ego-robot or ego-vehicle which may be operated in a multi-agent environment.

The system 100 for generating the generative trajectory model may be implemented as a robot agent or as a vehicle agent. During a training phase, the system 100 for generating the generative trajectory model may train the generative trajectory model 220. During an execution phase, the system 100 for generating the generative trajectory model may be a system that utilizes the generative trajectory model 220 to perform path planning for an ego-agent, such as an ego-vehicle or ego-robot. The memory 104 may store one or more instructions. The processor 102 may execute one or more of the instructions stored on the memory 104 to perform one or more acts, actions, and/or steps.

The non-interactive model 204, the game-theoretic model 208, and the generative trajectory model 220 may be stored on the storage drive 106 or memory 104 in the system 100 for generating the generative trajectory model. According to one aspect, the non-interactive model 204, the game-theoretic model 208, and the generative trajectory model 220 may be trained on an external server during the training phase, and communicated from or downloaded from the external server (not shown) via a network 148 and receive processed output data from an external server to the system 100 for the execution phase.

The processor 102 may perform generating the non-interactive model 204. The non-interactive model 204 may calculate probability distributions of predicted future trajectories for a first agent and a second agent based on a first portion of measured trajectory for each agent. The first agent may be an ego-agent and the second agent may be an adjacent agent operating adjacent to the ego-agent. The non-interactive model 204 may assume that each agent operates independently of one another. The non-interactive model 204 may utilize a conditional variational autoencoder (CVAE) to generate the probability distributions of predicted future trajectories.

By leveraging the CVAE-based generative trajectory model, the system 100 for generating the generative trajectory model according to the present disclosure may be capable of providing the advantage or benefit of inferring high-dimensional, multi-modal behavior distributions from noisy offline data while adapting in real-time to new online observations. Thus, the generative trajectory model 220 according to the present disclosure may provide significant improvements to the technical field of autonomous driving or operation.

The processor 102 may perform generating the game-theoretic model 208. The game-theoretic model 208 may evaluate the probability distributions of predicted future trajectories based on a parameterized cost function and may calculate a set of updated probability distributions of predicted future trajectories based on the evaluation. The parameterized cost function may include a deep neural network trained to represent an inter-agent interaction between the first agent and the second agent.

The game-theoretic model 208 may use a Bayesian recursive Nash equilibrium to calculate the set of updated probability distributions of predicted future trajectories. The Bayesian Recursive Nash Equilibrium may iteratively update sample weights of the predicted future trajectories to minimize expected costs between the first and second agents from the nominal strategy distributions.

The processor 102 may perform training the generative trajectory model 220 that combines the non-interactive model 204 and the game-theoretic model 208 by calculating a training loss based on the set of updated probability distributions and a second portion of the measured trajectory for each agent and optimizing the parameterized cost function by minimizing the training loss through gradient descent. In other words, the non-interactive model 204, the game-theoretic model 208, and the generative trajectory model 220 may be trained by using measured trajectories of multiple agents (e.g., taken as ground truth).

The sensors 140 may include a camera or an image capture device, along with a camera tracking system, to measure the trajectories of adjacent agents. According to one aspect, the sensors 140 may include an inertial sensors, a global positioning system (GPS) sensor, and/or gyroscope to measure a trajectory of an ego-agent.

The processor 102 may perform collecting real-time trajectories for the ego-agent and the adjacent agent from sensors 140 of the ego-agent. The processor 102 may perform calculating, by the non-interactive model 204, probability distributions of predicted future trajectories for the ego-agent and the adjacent agent based on the collected real-time trajectories. The processor 102 may perform calculating, by the game-theoretic model 208, a set of updated probability distributions of predicted future trajectory for the ego-agent by evaluating the probability distributions of predicted future trajectories for the ego-agent and the adjacent agent based on the parameterized cost function. The processor 102 may perform performing a path planning to generate a future trajectory for the ego-agent based on the set of updated probability distributions of predicted future trajectory.

The controller 130 and/or the processor 102 may perform controlling the ego-agent to drive or operate to a destination based on the generated future trajectory via one or more of the actuators 112.

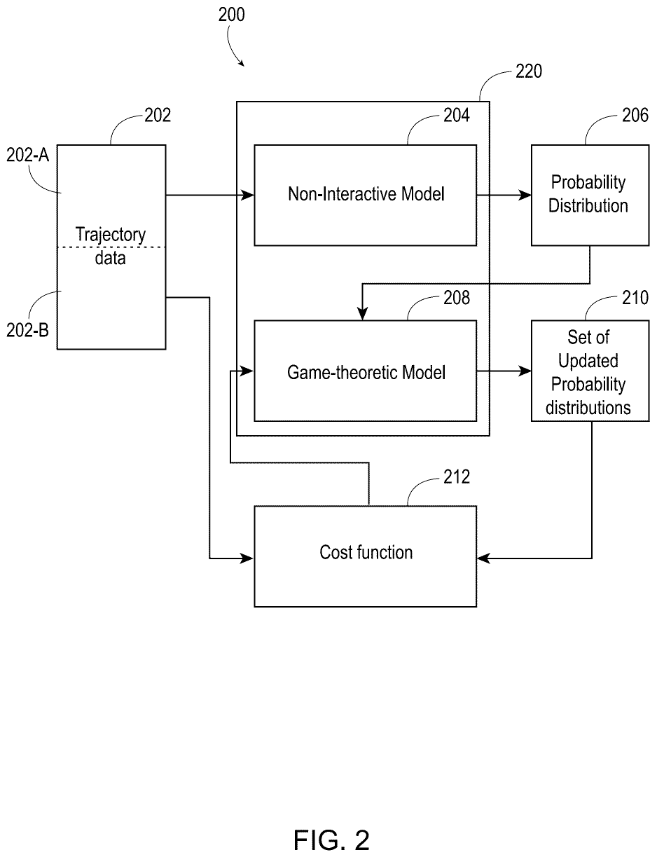

FIG. 2 is an illustration of an exemplary schematic representation of an algorithm 200 of training a generative trajectory model, according to one aspect. The algorithm 200 for training the generative trajectory model may include a trajectory data 202, the non-interactive model 204 outputting a probability distribution 206 based on a first portion 202-A of the trajectory data 202, a game-theoretic model 208 outputting a set of updated probability distributions 210, and a cost function 212 to update the game-theoretic model 208.

The following includes notations and definitions of selected terms employed in the game theory models, inverse game models.

### A. Notations

It may be assumed that N agents indexed by the set J={1, . . . , N}. The state of agent i∈J at time t is denoted as xᵢ^{t}, following which the trajectory of the agent from time t₁ to time t₂ is denoted as xᵢ^{t}^{₁}^{:t}^{₂}. For both the state and trajectory notations, the subscript J is used to denote the set of all agents' states and trajectories, such that

$${x}_{𝒥}^{t} = {\{ {x}_{i}^{t} \}}_{i ∈ 𝒥}$$

and

$${x}_{𝒥}^{{t}_{1} : {t}_{2}} = {\{ {x}_{i}^{{t}_{1} : {t}_{2}} \}}_{i ∈ 𝒥} .$$

it may be assumed that the states of all the agents are within the same state set X.

The temporal evolution of each agent's state may be governed by the dynamics

$${x}_{i}^{t + 1} = {f}_{i} ( {x}_{i}^{t} , {u}_{i}^{t} ) ,$$

where

$${u}_{i}^{t}$$

is the control. Under the dynamics constraints, the set of feasible trajectories between time t₁ and t₂ of all agents is denoted as S^{t}^{₁}^{:t}^{₂}.

A probability distribution of a trajectory between time t₁ and t₂ is denoted as

$$p ( {x}_{1}^{{t}_{1} : {t}_{2}} ) .$$

The set of all feasible probability density functions of trajectories between time t₁ and t₂ is denoted as

$${𝒫}^{{t}_{1} : {t}_{2}} = \{ p \vert p : {𝒮}^{{t}_{1} : {t}_{2}} ↦ {\text{?}}_{0}^{5} , {\int }_{{𝒮}^{{t}_{1} : {t}_{2}}} p ( s ) ds = 1 \} .$$

Similar to the trajectory notations, the subscript pᵢ is used to denote the probability distribution of agent i's trajectory.

### B. Games and Nash Equilibrium

In generating and utilizing the generative trajectory model, this disclosure discusses trajectory games, where the decision of each agent is represented by their trajectory, but the problem formulation and the derivations are compatible with and may be generalized to other games.
Definition 1 (Pure strategy trajectory game): Given the time window t₀ to t_{f} an N-player pure strategy trajectory game may be defined as the tuple of (J, S^{t}^{₀}^{:t}^{_{f}},J):

$$𝒥 = {\{ {J}_{i} ( {x}_{1}^{{t}_{0} : {t}_{f}} , … , {x}_{i}^{{t}_{0} : {t}_{f}} , … , {x}_{N}^{{t}_{0} : {t}_{f}} ) \}}_{i ∈ 𝒥} , \qquad ( 1 )$$

where J is the agent index set, S^{t}^{₀}^{:t}^{_{f}} is the set of feasible trajectories within the time window, J is the set of trajectory objectives for all agents, and each agent's planned trajectory is referred to as a pure strategy.
Definition 2 (Pure strategy Nash equilibrium): Given the game (J, S^{t}^{₀}^{:t}^{_{f}},J), a pure strategy Nash equilibrium may be a set of trajectories {sᵢ^{*}∈S^{t}^{₀}^{:t}^{_{f}}}_{i∈J} that satisfies the following:

$${s}_{i}^{*} = {argmin}_{{s}_{i}} {J}_{i} ( {s}_{i}^{*} , … , {s}_{i} , … , {s}_{N}^{*} ) , \qquad ( 2 )$$

$$∀ i ∈ 𝒥 ,$$

Definition 3 (Mixed strategy trajectory game): Given the time window t₀ to t_{f}, an N-player mixed strategy trajectory game is defined as the tuple of (J,S^{t}^{₀}^{:t}^{_{f}},P^{t}^{₀}^{:t}^{_{f}},J), where the objective function set J is defined in Equation (1).
Definition 4 (Mixed strategy Nash equilibrium): Given the game (J,S^{t}^{₀}^{:t}^{_{f}},P^{t}^{₀}^{:t}^{_{f}},J), a mixed strategy Nash equilibrium may be a set of trajectory probability distributions {pᵢ^{*}∈P^{t}^{₀}^{:t}^{_{f}}}_{i∈J} that satisfies:

$${p}_{i}^{*} = {argmin}_{{p}_{i}} {𝔼}_{{p}_{i}^{*} , … , {p}_{i} , … , {p}_{N}^{*}} [ {J}_{i} ] , \qquad ( 3 )$$

$$∀ i ∈ 𝒥 ,$$

where the trajectory distribution of each agent is called a mixed strategy, and [symbol] ₚ_{₁}_{, . . . ,p}_{_{N}}[J] denotes joint expectation.

### C. Inverse Games

The inverse game problem may be framed as a parameter estimation problem for a pure strategy game, solved using maximum likelihood estimation MLE or Bayesian inference, with online or offline observations. Additionally, the method focuses on online inference of local Nash equilibrium from runtime observations, where the game model is predefined, but multiple locally optimal Nash equilibrium solutions may exist.
Definition 5 (Inverse pure strategy game): Given a multi-agent joint trajectory dataset D^{t}^{₀}^{:t}^{_{f}} defined as:

$${𝒟}^{{t}_{0} : {t}_{f}} = \{ ( {x}_{1 , d}^{{t}_{0} : {t}_{f}} , … , {x}_{N , d}^{{t}_{0} : {t}_{f}} ) \} d , \qquad ( 4 )$$

and a parameterized pure strategy game (J,S^{t}^{₀}^{:t}^{_{f}},J):

$${𝒥}_{θ} = {\{ {J}_{i , θ} ( {x}_{1}^{{t}_{0} : {t}_{f}} , … , {x}_{i}^{{t}_{0} : {t}_{f}} , … , {x}_{N}^{{t}_{0} : {t}_{f}} ) \}}_{i ∈ 𝒥} , \qquad ( 5 )$$

where the inverse pure strategy game problem involves fitting the game model parameter θ to the joint trajectory dataset.
Assumption 1 (Pure strategy Nash-optimality): Observed behaviors in the dataset (4) may be governed by a pure strategy Nash equilibrium (2) {s_{i,θ}^{*}∈S^{t}^{₀}^{:t}^{_{f}}}_{i∈J} under an unknown game model parameter θ. The joint trajectories in the dataset (4) may be samples from a measurement model:

$${x}_{i , d}^{{t}_{0} : {t}_{f}} \sim g ( {x}^{{t}_{0} : {t}_{f}} \vert {s}_{i , θ}^{*} ) , \qquad ( 6 )$$

$$∀ i ∈ 𝒥$$

Based on Assumption 1, the inverse game problem may be solved as a maximum likelihood estimation (MLE) problem:

$${θ}^{*} = {argmax}_{θ} {\prod }_{d} {\prod }_{i = 1}^{N} g ( {x}_{i , d}^{{t}_{0} : {t}_{f}} \vert {s}_{i , θ}^{*} ) , \qquad ( 7 )$$

$$s . t .$$

$${s}_{i , θ}^{*} = {argmin}_{{s}_{i}} {J}_{i , θ} ( {s}_{i , θ}^{*} , … , {s}_{i} , … , {s}_{N , θ}^{*} ) .$$

$$∀ i ∈ 𝒥 .$$

The MLE equation may reduce to a least-squares estimation problem if the conditional distribution is Gaussian. The MLE methods may provide a point estimation θ* of the pure strategy game parameter, which could lead to undesired actions under uncertainty. An alternative approach may be Bayesian inference, which infers a posterior distribution of the game parameter θ, but may be limited by the computation cost. In this regard, a variational autoencoder (VAE) may be trained on offline data to mitigate the computation cost of online Bayesian inference. However, the inference may be limited to lower-dimensional parameters (e.g., navigation goal), and the pure strategy game equation used by the method does not inherently account for uncertainty in decision-making.

### D. Inverse Mixed Strategy Games

The algorithm 200 for training the generative trajectory model may take an approach to integrate uncertainty into inverse games by extending Definition 5 and Assumption 1 from pure strategy to mixed strategy.
Definition 6 (Inverse mixed strategy game): Given a joint trajectory dataset D^{t}^{₀}^{:t}^{_{f}} (4) and a parameterized mixed strategy trajectory game (J,S^{t}^{₀}^{:t}^{_{f}},P^{t}^{₀}^{:t}^{_{f}},J_{θ}), the inverse mixed strategy game problem may involve inferring the game model parameter θ from the joint trajectory dataset.

Assumption 2 (Mixed strategy Nash-optimality): The behaviors in the dataset Equation (4) may be governed by a mixed strategy Nash equilibrium (3) {p_{i,θ}^{*}∈P^{t}^{₀}^{:t}^{_{f}}}_{i∈J} under an unknown game model parameter θ. The joint trajectories in the dataset (4) may be samples from the mixed strategy Nash equilibrium equation:

$${x}_{i , d}^{{t}_{0} : {t}_{f}} \sim {p}_{i , θ}^{*} ( {x}^{{t}_{0} : {t}_{f}} ) , \qquad ( 8 )$$

$$∀ i ∈ 𝒥 .$$

Based on Assumption 2, the inverse mixed strategy game problem may be solved as a MLE problem similar to Equation (7):

$${θ}^{*} = {argmax}_{θ} {\prod }_{d} {\prod }_{i = 1}^{N} {p}_{i , θ}^{*} ( {x}^{{t}_{0} : {t}_{f}} ) , \qquad ( 9 )$$

$$s . t .$$

$${p}_{i , θ}^{*} = {argmin}_{{p}_{i}} {𝔼}_{{p}_{1 , θ}^{*} , … , {p}_{i} , … , {p}_{N , θ}^{*} [ {J}_{i , θ} ] ,}$$

$$∀ i ∈ 𝒥 .$$

Although the MLE equation still provides a point estimate, unlike pure strategy inverse games, the mixed strategy game model may naturally incorporate uncertainty by representing inferred decisions as probability distributions, thereby relaxing the strict rationality assumption in Assumption 1.

An inverse mixed strategy game method may be proposed for both offline and online observations. However, the mixed strategy may be limited to a fixed number of trajectory samples, which needs to be predetermined before learning. In the next section, the algorithm 200 for training the generative trajectory model may utilize an inverse mixed strategy game method, which uses generative trajectory models or conditional variational autoencoders (CVAEs) as the mixed strategy for inference with both offline and online observations. Variational autoencoders (VAEs) and CVAEs have been applied for generative trajectory modeling in trajectory prediction, reinforcement learning, and self-supervised behavior analysis.

Algorithm A and Algorithm B below may be exemplary pseudo codes for generating and training the generative trajectory model 220, according to one aspect.

Algorithm A: Inverse Mixed Strategy Game (One Iteration)

| | | |
|---|---|---|
| 1: | procedure INVERSEGAME $( θ , {\{ {ζ}_{d}^{t} \}}_{t , d} )$ | [symbol] ${ζ}_{d}^{t}$ in eq. (19) |
| 2: | loss ← 0 | [symbol] Initial Loss |

| | |
|---|---|
| 3: | for Each ${ζ}_{d}^{t}$ |
| | in the batch do |
| 4: | Generate nominal samples ${\{ {s}_{i , k , d}^{t} \}}_{i , k}$ |
| | from Equation (22) |
| 5: | ${\{ {w}_{i , k , d}^{t} \}}_{i , k} ← FORWARDGAME ( {l}_{θ} , {\{ {s}_{i , k , d}^{t} \}}_{i , k} )$ |
| 6: | for Each agent i do |
| 7: | $loss ← loss + {\sum }_{k} {w}_{i , k , d}^{t} \cdot {‖ {\overline{s}}_{i , d}^{t} - {s}_{i , k , d}^{t} ‖}^{2}$ |
| 8: | θ ← BACKPROPAGATION(θ, loss) |
| 9: | return θ |

Algorithm B: Forward Mixed Strategy Game

| 1: | procedure FORWARDGAME $( {l}_{θ} , {\{ {x}_{i , k}^{{t}_{0} , {t}_{f}} \}}_{{\{ {w}_{i , k}^{[ m ]} \}}_{i ∈ 𝒥 , k}} )$ | |
|---|---|---|
| 2: | m ← 0 | [symbol] m is the iteration index. |

| | |
|---|---|
| 3: | for each sample k of each agent i ϵ J do |
| 4: | Initialize weights ${\{ {w}_{i , k}^{[ m ]} \}}_{k} ← {\{ \frac{1}{K} \}}_{k}$ |
| 5: | while exit criterion not met do |
| 6: | for each agent i ϵ J do |
| 7: | Update weight ${w}_{i , k}^{[ m + 1 ]}$ |
| | of each sample in Equation (13) |
| 8: | m ← m + 1 |
| 9: | $return {\{ {w}_{i , k}^{[ m ]} \}}_{i ∈ 𝒥 , k}$ |

Algorithm A may begin with initializing the parameters, including a training loss. Then, Algorithm A, at line 4, may include performing the non-interactive model 204 to generate nominal samples of the mixed strategies for each agent.

Subsequently, Algorithm A, line 5, may call the procedure FORWARDGAME described in Algorithm B.

Algorithm B may perform the game-theoretic model 208 to model multi-agent interactions through Bayesian recursive Nash equilibrium (BRNE), described in greater detail herein. The game-theoretic model 208 may be a forward mixed strategy game for solving the mixed strategy game for multiple agents and assign weights for the predicted future trajectories outputted from the non-interactive model 204.

Returning to Algorithm A, at line 6, Algorithm A may initiate the process of one optimization iteration for the game-theoretic model 208. Algorithm A, at lines 6-7, may compute the training loss for improving the game representation and representation of behavior in the game-theoretic model 208. The training loss may be a sum of differences between the weighted average of the samples and the measured trajectories for each agent.

Algorithm A, at line 8, may include computing the gradient of the parameter θ which describes the game with respect to this loss, and performing a back propagation gradient descent.

As shown in FIG. 2, the algorithm 200 of training the generative trajectory model 220 may include feeding a first portion 202-A of trajectory data to the non-interactive model 204 that may calculate probability distributions of predicted future trajectories for a first agent and a second agent based on a first portion 202-A of measured trajectory data 202 for each agent, in which the non-interactive model 204 assumes that each agent operates independently of one another.

The algorithm 200 of training the generative trajectory model 220 may utilize a forward game from Equation (21) below, which may represent the nominal mixed strategies as trajectory samples of predicted future trajectories for each agent. In other words, the non-interactive model 204 may construct the nominal mixed strategies q_{i,Φ} using generative trajectory models.

Subsequently, the algorithm 200 may include generating the game-theoretic model 208 that may evaluate the probability distributions of predicted future trajectories based on a parameterized cost function. The game-theoretic model 208 may include a Bayesian recursive Nash equilibrium (BRNE) algorithm to calculate a set of updated probability distributions of predicted future trajectories based on the evaluation. In this way, the game-theoretic model 208 may incorporate inter-agent interactions among the multi-agents.

### Inverse Mixed Strategy Games Using Generative Trajectory Models

### A. Forward Mixed Strategy Games

The algorithm 200 may use the generalized mixed strategy games equation, which may be solved efficiently through an iterative algorithm named Bayesian recursive Nash equilibrium (BRNE). Specifically, the parameterized objective function of agent i, denoted as

$${J}_{i [ θ , ϕ ]} ( {x}_{1}^{{t}_{0} : {t}_{f}} , … , {x}_{N}^{{t}_{0} : {t}_{f}} )$$

is specified as:

$${J}_{i [ θ , ϕ ]} = {\sum }_{j ∈ 𝒥}^{j \neq i} {l}_{θ} ( {x}_{i}^{{t}_{0} : {t}_{f}} , {x}_{j}^{{t}_{0} : {t}_{f}} ) + log ( \frac{{p}_{i} ( {x}_{i}^{{t}_{0} : {t}_{f}} )}{{q}_{i , ϕ} ( {x}_{i}^{{t}_{0} : {t}_{f}} )} ) \qquad ( 10 )$$

In the above Equation, I_{θ}(⋅,~) denotes a parameterized cost function that evaluates over two joint pure strategies (trajectories), pᵢ(⋅) is the mixed strategy of agent i. Furthermore, q_{i,Φ}(⋅) is a parameterized trajectory distribution named as the nominal strategy of agent i, representing agent i's individual intent without the presence of other agents.

Following Definition 3, the mixed strategy Nash equilibrium (3) {pᵢ^{*}∈P^{t}^{₀}^{:t}^{_{f}}}_{i∈J} for Equation (10) is:

$${p}_{i}^{*} = {argmin}_{{p}_{i}} {\sum }_{j ∈ 𝒥}^{j \neq i} {𝔼}_{{p}_{i} , {p}_{j}^{*}} [ {l}_{θ} ] + D ( {p}_{i} ‖ {q}_{i , ϕ} ) , \qquad ( 11 )$$

$$∀ i ∈ 𝒥$$

where D(p∥q) is the Kullback-Leibler (KL) divergence.

There are two terms in Equation (11): the first term captures the expected cost between agent i and other agents, while the second term preserves agent i's nominal mixed strategy. It is noted that the relative weight between the two terms may be a parameter of the cost function I_{θ}.

This structure of combining expected costs with a KL-divergence regulatory term may not be unique in this specific game equation, with examples including a model predictive path integral (MPPI) control and the corresponding game equation. Furthermore, the nominal mixed strategy q_{i,Φ} may be introduced as a priori behavioral distribution that may be learned from data.

Subsequently, the algorithm 200 for training the generative trajectory model may generate a game-theoretic model 208 that evaluates the probability distributions of predicted future trajectories based on a parameterized cost function 212 and calculates a set of updated probability distributions 210 of predicted future trajectories based on the evaluation. The cost function 212 may perform an inverse game training, in which the sampled strategies and computed weights may be used to evaluate the log-likelihood of measured trajectories of each agent, and the cost function parameters may be updated via backpropagation using gradients from a BRNE's output.

To solve the mixed strategy game Equation (11), the game-theoretic model 208 may use a Bayesian recursive Nash equilibrium (BRNE) algorithm, which iteratively updates the mixed strategies of all agents in a sequential order.

The current iteration number may be denoted as m and the mixed strategy of agent i at the current iteration as pᵢ^{[m}](xᵢ^{t}^{₀}^{:t}^{_{f}}), and the algorithm 200 sequentially may update each agent's mixed strategy through the following:

$${p}_{i}^{[ m + 1 ]} = η \cdot {p}_{i}^{[ m ]} ( {x}_{i}^{{t}_{0} : {t}_{f}} ) \cdot exp ( - {h}_{i}^{[ m ]} ( {x}_{i}^{{t}_{0} : {t}_{f}} ) ) , \qquad ( 12 )$$

$${h}_{i}^{[ m ]} = {\sum }_{j ∈ 𝒥}^{j < i} {𝔼}_{{p}_{j}^{[ m + 1 ]}} [ {l}_{θ} ( {x}_{i}^{{t}_{0} : {t}_{f}} , \cdot ) ] + {\sum }_{j ∈ 𝒥}^{j > i} {𝔼}_{{p}_{j}^{[ m ]}} [ {l}_{θ} ( {x}_{i}^{{t}_{0} : {t}_{f}} , \cdot ) ] ,$$

where η is the normalization term and

$${p}_{i}^{[ 0 ]} = {q}_{i , ϕ} .$$

However, directly evaluating Equation (12) is intractable.

Instead, the mixed strategy

$${p}_{i}^{[ m ]} ( {x}_{i}^{{t}_{0} : {t}_{f}} )$$

may be represented as K weighted samples

$${\{ ( {x}_{i , k}^{{t}_{0} : {t}_{f}} , {w}_{i , k}^{[ m ]} ) \}}_{k} ,$$

where the samples are initially generated from the nominal mixed strategy

$${x}_{i , k}^{{t}_{0} : {t}_{f}} ∼ {q}_{i , ϕ} ( {x}_{i}^{{t}_{0} : {t}_{f}} ) ,$$

such that Equation (12) may be asymptotically approximated as:

$${w}_{i , k}^{[ m + 1 ]} = η \cdot {w}_{k}^{[ m ]} \cdot exp ( - {\overline{h}}_{i}^{[ m ]} ( {x}_{i , k}^{{t}_{0} : {t}_{f}} ) ) \qquad ( 13 )$$

$${\overline{h}}_{i}^{[ m ]} ( {x}_{i , k}^{{t}_{0} : {t}_{f}} ) = {\sum }_{j ∈ 𝒥}^{j < i} {\sum }_{{k}^{′} = 1}^{K} {w}_{j , k}^{[ m + 1 ]} \cdot {l}_{θ} ( {x}_{i , k}^{{t}_{0} : {t}_{f}} , {x}_{j , {k}^{′}}^{{t}_{0} : {t}_{f}} ) + {\sum }_{j ∈ 𝒥}^{i > i} {\sum }_{{k}^{′} = 1}^{K} {w}_{j , k}^{[ m ]} \cdot {l}_{θ} ( {x}_{i , k}^{{t}_{0} : {t}_{f}} , {x}_{j , {k}^{′}}^{{t}_{0} : {t}_{f}} ) \qquad ( 14 )$$

where η is the normalization term to ensure

$${\sum }_{k} {w}_{i , k}^{[ m + 1 ]} = 1 .$$

The iterative process of the BRNE may be described by Algorithm B. The BRNE may guarantee the convergence to a Nash equilibrium and a lower-bounded reduction of the joint expected cost between agents.

As shown in Equation (13) and Algorithm B, given the initial samples from the nominal mixed strategies, the calculations involved in weight update may be fully differentiable, which is a useful property for solving the inverse game of Equation (9).

To solve the inverse game problem for the Equation (11), the processor 102 may optimize the parameter θ and φ separately to make the computation tractable.

### B. Generative Trajectory Models as Mixed Strategies

The measured trajectory for each agent may include an offline dataset of multi-agent joint trajectories between time 0 to T that is denoted as

$${𝒟}^{0 : T} = {\{ ( {x}_{1 , d}^{0 : T} , … , {x}_{N , d}^{0 : T} ) \}}_{d} .$$

The nominal mixed strategy may be specified as a parameterized conditional probability distribution of the predicted future trajectories for each agent from a receding horizon perspective:

$${q}_{i , ϕ} ( {x}_{i}^{t : t + {τ}_{1}} ) = {p}_{ϕ} ( {x}_{i}^{t : t + {τ}_{1}} \vert {x}_{i}^{t - {τ}_{2} : t} , {β}_{i} ) , ∀ t ∈ [ {τ}_{2} , T - {τ}_{1} ] \qquad ( 15 )$$

where τ₁ is the horizon of inferred future states, τ₂ is the horizon of observed past states, βᵢ is a task-relevant variable of agent i given a priori (e.g., navigation goal), and the parameter φ characterizes the conditional distribution.

The parameter φ may be optimized by solving the following maximum likelihood estimation problem:

$${ϕ}^{*} = {arg max}_{ϕ} {\prod }_{d} {\prod }_{i = 1}^{N} {\prod }_{t = {τ}_{2}}^{T - {τ}_{1}} {p}_{ϕ} ( {x}_{i , d}^{t : t + {τ}_{1}} \vert {x}_{i , d}^{t - {τ}_{2}} , {β}_{i} ) \qquad ( 16 )$$

It is noted that even though multi-agent joint trajectory data are given, the training of the nominal mixed strategy may be based on the individual trajectory of each agent. In other words, the non-interactive model 204 may assume that each agent operates independently of one another, and the nominal mixed strategy may not capture any inter-agent interaction.

The nominal mixed strategy may be generated using a conditional variational autoencoder based on the first portion of measured trajectory for each agent. The conditional probability distribution Equation (15) may be specified as a conditional variational autoencoder.

To simplify the notation,

$${x}_{i}^{t : t + {τ}_{1}}$$

is replaced with

$${s}_{i}^{t}$$

to denote the inferred future trajectory, and

$${c}_{i}^{t} = [ {x}_{i}^{t - {τ}_{2} : t} , {β}_{i} ]$$

is used to denote the joint conditional variable.

The non-interactive model 204 may utilize a conditional variational autoencoder to generate the probability distributions of predicted future trajectories. The CVAE may represent the conditional probability distribution Equation (15) as a marginalized distribution over a low-dimensional latent variable z whose prior distribution may be the standard Gaussian distribution.

During the training phase, the conditional probability distribution Equation (15) may be approximated as:

$${p}_{ϕ} ( {s}_{i}^{t} \vert {c}_{i}^{t} ) \approx \int {p}_{o , ϕ} ( {s}_{i}^{t} \vert {c}_{i}^{t} , z ) {p}_{e , ϕ} ( z \vert {s}_{i}^{t} , {c}_{i}^{t} ) d z \qquad ( 17 )$$

where p_{e,φ} is a probability distribution characterized by an encoder network and p_{o,φ} is characterized by a decoder network.

After the training stage, the algorithm 200 may use the optimized decoder network p_{o,φ}_{^{*}} for inference, in which case the nominal mixed strategy Equation (15) is represented as:

$${q}_{i} ( {s}_{i}^{t} ) = \int {p}_{o , ϕ} * ( {s}_{i}^{t} \vert {c}_{i}^{t} , z ) {p}_{𝒩} ( z ; 0 , 1 ) d z \qquad ( 18 )$$

From Equation (18), trajectory samples of the predicted future trajectories may be generated for the forward mixed strategy game, which solves the mixed strategy game and assigns weights for the trajectories of the non-interactive model 204.

Using the CVAE to model the nominal mixed strategy Equation (15) may allow inferring with both offline and online observations. The training of the CVAE may use the offline dataset to capture the prior statistical pattern in agent behaviors, and may generate new nominal mixed strategies conditioned on online observations.

The inverse mixed strategy problem in Equation (9) may be solved by learning the cost function I_{θ} in Equation (10).

### C. Inverse Mixed Strategy Game

The system 100 for generating the generative trajectory model 220 may model the inter-agent cost function I_{θ}(⋅,⋅) in Equation (10) as a neural network and optimize the parameter θ over the same offline dataset

$${𝒟}^{0 : T} = {\{ ( {x}_{1 , d}^{0 : T} , … , {x}_{N , d}^{0 \cdot T} ) \}}_{d}$$

as in Equation (16). Similar to the training of the CVAE model, the system 100 may take the receding horizon approach to separate each set of joint trajectories

$$( {x}_{1 , d}^{0 : T} , … , {x}_{N , d}^{0 : T} )$$

into past observations and future states D={ζ_{d}^{t}}:

$${ζ}_{d}^{t} = ( ( {o}_{1 , d}^{t} , … , {o}_{N , d}^{t} ) , ( {\overline{s}}_{1 , d}^{t} , … , {\overline{s}}_{N , d}^{t} ) ) \qquad ( 19 )$$

Here, the notation is simplified by denoting past states

$${x}_{i , d}^{t - {τ}_{2} : t}$$

(or the first portion 202-A of measured trajectory data) as o_{i,d}^{t} and future states

$${x}_{i , d}^{t : t + {τ}_{1}}$$

as

$${\overline{s}}_{i , d}^{t}$$

(or the second portion 202-B of measured trajectory data) from the dataset.

Following Equation (10) and Equation (11), the MLE problem introduced in Equation (9) for the inverse mixed strategy game may be specified with the log-likelihood equation below:

$${θ}^{*} = {arg max}_{θ} {Σ}_{d} {Σ}_{i = 1}^{N} {Σ}_{t = {τ}_{2}}^{T - {τ}_{1}} log {p}_{i , d , θ}^{t *} ( {\overline{s}}_{i , d}^{t} ) . \qquad ( 20 )$$

Evaluating

$${p}_{i , d , θ}^{t *} ( {\overline{s}}_{i , d}^{t} )$$

may be accomplished by solving the forward game:

$${p}_{i , d , θ}^{t *} = {arg min}_{{p}_{i , d}^{t}} {\sum }_{j ∈ 𝒥}^{j \neq i} {𝔼}_{{p}_{i , d}^{t} , {p}_{j , d , θ}^{t *}} [ {l}_{θ} ] + D ( {p}_{i , d}^{t} \vert \vert {q}_{i , d , {ϕ}^{*}}^{t} ) \qquad ( 21 )$$

$${q}_{i , d , {ϕ}^{*}}^{t} ( {s}_{i}^{t} ) = \int {p}_{o , {ϕ}^{*}} ( {s}_{i}^{t} \vert {o}_{i , d}^{t} , {β}_{i} , z ) {p}_{𝒩} ( z ; 0 , 1 ) d z \qquad ( 22 )$$

To evaluate the MLE objective Equation (20), Algorithm B may serve as a differentiable solver for the forward game Equation (21), which represents the nominal mixed strategies as sets of trajectory samples:

$${\{ {s}_{i , k , d}^{t} \}}_{k} ∼ {q}_{i , d}^{t} ( {s}_{i , d}^{t} ) .$$

Algorithm B then may return optimal sample weights

$${\{ {w}_{i , k , d}^{t} \}}_{i ∈ 𝒥 , k}$$

such that the weighted samples represent the optimal mixed strategy from the corresponding mixed strategy Nash equilibrium

$${\{ ( {s}_{i , k , d}^{t} , {w}_{i , k , d}^{t} ) \}}_{k} ∼ {p}_{i , d , θ}^{t *} ( {s}_{i , d}^{t} ) . \qquad Equation ( 21 )$$

The optimal sample weights

$${\{ {w}_{i , k , d}^{t} \}}_{i ∈ 𝒥 , k}$$

may be a set of updated probability distributions 210 of predicted future trajectories that may be calculated by the game-theoretic model 208 based on the evaluation.

Next, the non-interactive model 204 and the game-theoretic model 208 may be combined to generate the generative trajectory model 220. The processor 102 may train the generative trajectory model 220 by calculating a training loss based on the set of updated probability distributions and the second portion 202-B of the measured trajectory for each agent, and optimizing the parameterized cost function by minimizing the training loss through gradient descent.

The training loss may be calculated as

$$loss ← loss + {Σ}_{k} {w}_{i , k , d}^{t} \cdot {‖ {\overline{s}}_{i , d}^{t} - {s}_{i , k , d}^{t} ‖}^{2} ,$$

where

$${s}_{i , k , d}^{t}$$

is a weighted sample of predicted future trajectories and s̅_{i,d}^{t} is the second portion of the measured trajectory for each agent.

The sample-based mixed strategy representation approximates the log-likelihood Equation (20):

$$log {p}_{i , d , θ}^{t *} ( {\overline{s}}_{i , d}^{t} ) \approx - {Σ}_{k} {w}_{i , k , d}^{t} \cdot {‖ {\overline{s}}_{i , d}^{t} - {s}_{i , k , d}^{t} ‖}^{2} \qquad ( 23 )$$

Since the whole process of evaluating the MLE objective Equation (20) may be differentiable, the cost function parameter θ may be iteratively optimized through backpropagation by minimizing the training loss through gradient descent. The training loss may be defined as a sum of differences between an average of the predicted future trajectories and the measured trajectory for each agent.

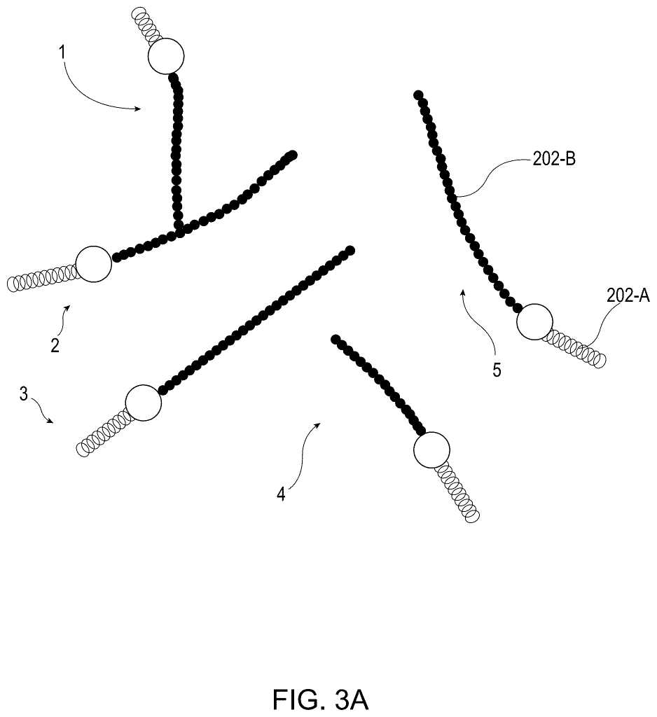

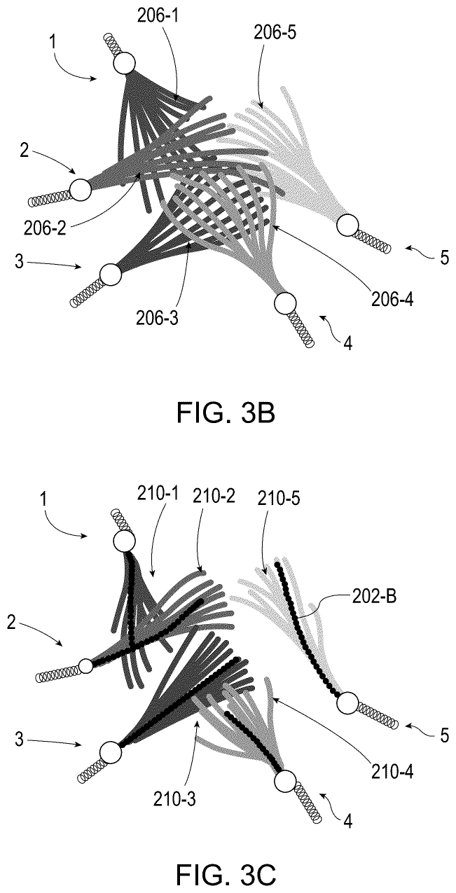

FIG. 3A is an illustration of exemplary measured trajectories of multi-agents, according to one aspect. As illustrated in FIG. 3A, five agents may move simultaneously in a same space, and the movements of the five agents may have been measured and recorded as measured trajectories 1, 2, 3, 4 and 5 over a period of time. One of the five agents may be an ego-agent, and the other four agents may be adjacent agents operating in proximity to the ego-agent.

Each measured trajectory may be divided into the first portion 202-A and the second portion 202-B based on respective midpoints. The first portion 202-A of the measured trajectory may correspond to past observations, and the second portion 202-B of measured trajectory may correspond to future states in the training stage. The first portion 202-A of measured trajectory may be fed into the non-interactive model 204, and the second portion 202-B of measured trajectory may be used to calculate the training loss when training the game-theoretic model 208.

FIG. 3B is an illustration of exemplary probability distributions of predicted future trajectories of multi-agents before solving the inverse game of Equation (20), according to one aspect. The probability distributions of predicted future trajectories 206-1, 206-2, 206-3, 206-4, and 206-5 for each agent may be Nash equilibrium mixed strategies generated from the non-interactive model 204. The non-interactive model 204 may assume that each agent operates independently of one another, and the nominal mixed strategy may not capture any inter-agent interaction.

FIG. 3C is an illustration of exemplary updated probability distributions of predicted future trajectories of multi-agents after solving the inverse game Equation (20), according to one aspect. The updated probability distributions of predicted future trajectories 210-1, 210-2, 210-3, 210-4, and 210-5 for each agent may be calculated by the game-theoretic model 208, which has been trained via the algorithm 200 in FIG. 2. These updated probability distributions of predicted future trajectories in FIG. 3C have less overlap with other agents' future trajectories and more precise distributions, compared to the probability distributions of predicted future trajectories in FIG. 3B. Thus, the generative trajectory model 220 according to the present disclosure may enable more sophisticated and improved autonomous driving in multi-agent circumstances.

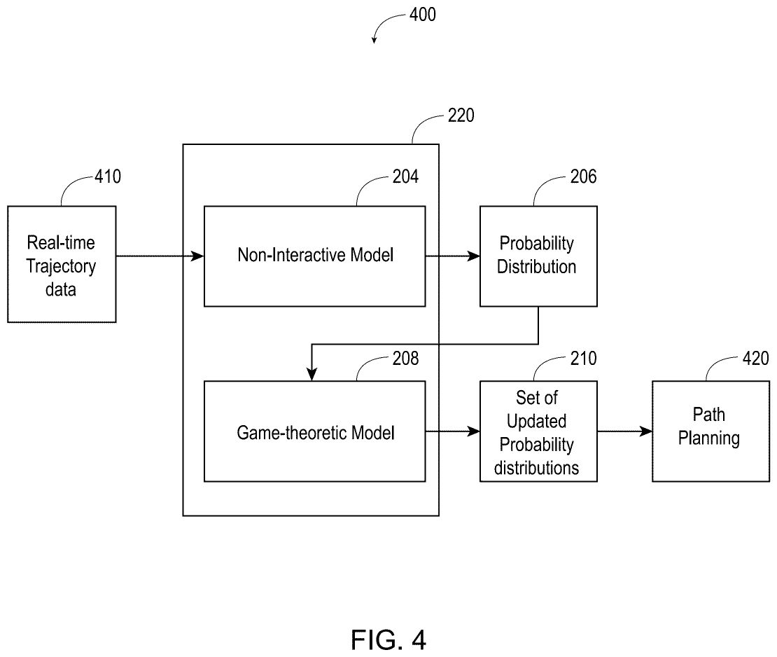

FIG. 4 is an illustration of an exemplary schematic representation of algorithm 400 of executing the generative trajectory model 220, according to one aspect.

The algorithm 400 may include a real-time trajectory data 410, a non-interactive model 204 outputting a probability distribution 206 based on the first portion 202-A of the trajectory data 202, a game-theoretic model 208 outputting a set of updated probability distributions 210, and a path planning 420.

The real-time trajectory data 410 may include real-time trajectories of multiple agents including an ego-agent and an adjacent agent. The real-time trajectories may include real-time trajectories of multiple agents which are being collected by the ego-agent's sensors 140 in a real driving situation.

The non-interactive model 204 may calculate probability distributions of predicted future trajectory data of the ego-agent and the adjacent agent based on the collected real-time data, assuming that each agent operates independently of one another.

The game-theoretic model 208 may calculate a set of updated probability distributions of predicted future trajectories for the ego-agent by evaluating the probability distributions of predicted future trajectories for the ego-agent and the adjacent agent based on the parameterized cost function.

The path planning 420 may perform path planning to generate a future trajectory for the ego-agent based on the set of updated probability distributions of predicted future trajectories. Based on the generated future trajectory, the controller 130 may control the steering and driving mechanisms of the ego-agent to drive to a destination during autonomous operation.

As described above, by representing each agent's mixed strategy using a conditional variational autoencoder (CVAE) and specifying the agent objective as a neural network, the generative trajectory model 220 according to one aspect may infer high-dimensional, multi-modal behavior distributions from noisy measurements while adapting in real-time to new observations. The method according to one aspect may infer Nash-optimal actions comparable to those of the ground-truth model and the oracle inverse game baseline, even in the presence of uncertain agent objectives and noisy measurements.

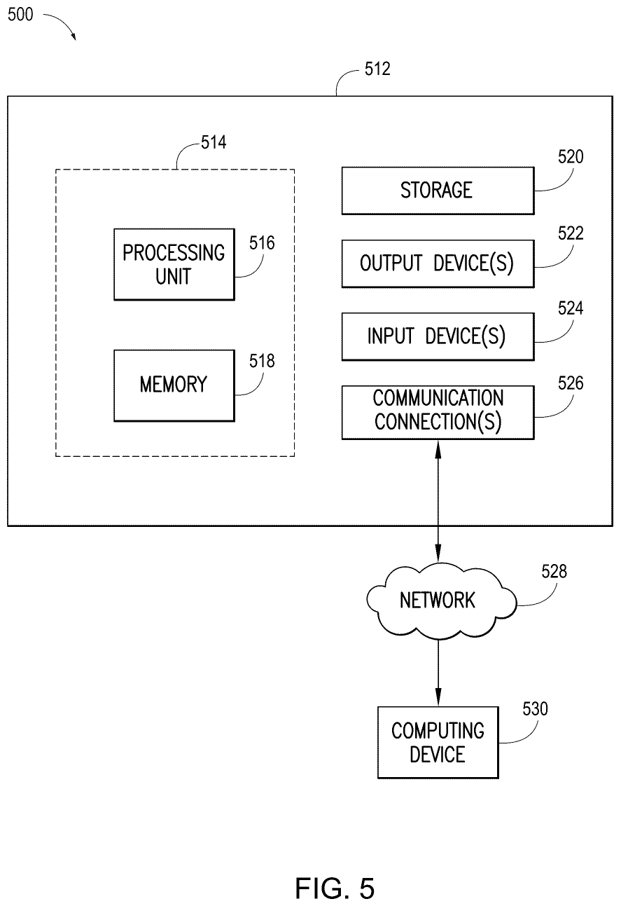

FIG. 5 and the following discussion provide a description of a suitable computing environment to implement aspects of one or more of the provisions set forth herein. The operating environment of FIG. 5 is merely one example of a suitable operating environment and is not intended to suggest any limitation as to the scope of use or functionality of the operating environment. Example computing devices include, but are not limited to, personal computers, server computers, hand-held or laptop devices, mobile devices, such as mobile phones, Personal Digital Assistants (PDAs), media players, and the like, multi-processor systems, consumer electronics, mini computers, mainframe computers, distributed computing environments that include any of the above systems or devices, etc.

Generally, aspects are described in the general context of “computer readable instructions” being executed by one or more computing devices. Computer readable instructions may be distributed via computer readable media as will be discussed below. Computer readable instructions may be implemented as program modules, such as functions, objects, Application Programming Interfaces (APIs), data structures, and the like, that perform one or more tasks or implement one or more abstract data types. Typically, the functionality of the computer readable instructions are combined or distributed as desired in various environments.

FIG. 5 illustrates a system 500 including a computing device 512 configured to implement one aspect provided herein. In one configuration, the computing device 512 includes at least one processing unit 516 and memory 518. Depending on the exact configuration and type of computing device, memory 518 may be volatile, such as RAM, non-volatile, such as ROM, flash memory, etc., or a combination of the two. This configuration is illustrated in FIG. 5 by dashed line 514.

In other aspects, the computing device 512 includes additional features or functionality. For example, the computing device 512 may include additional storage such as removable storage or non-removable storage, including, but not limited to, magnetic storage, optical storage, etc. Such additional storage is illustrated in FIG. 5 by storage 520. In one aspect, computer readable instructions to implement one aspect provided herein are in storage 520. Storage 520 may store other computer readable instructions to implement an operating system, an application program, etc. Computer readable instructions may be loaded in memory 518 for execution by the at least one processing unit 516, for example.

The term “computer readable media” as used herein includes computer storage media. Computer storage media includes volatile and nonvolatile, removable, and non-removable media implemented in any method or technology for storage of information such as computer readable instructions or other data. Memory 518 and storage 520 are examples of computer storage media. Computer storage media includes, but is not limited to, RAM, ROM, EEPROM, flash memory or other memory technology, CD-ROM, Digital Versatile Disks (DVDs) or other optical storage, magnetic cassettes, magnetic tape, magnetic disk storage or other magnetic storage devices, or any other medium which may be used to store the desired information and which may be accessed by the computing device 512. Any such computer storage media is part of the computing device 512.

The term “computer readable media” includes communication media. Communication media typically embodies computer readable instructions or other data in a “modulated data signal” such as a carrier wave or other transport mechanism and includes any information delivery media. The term “modulated data signal” includes a signal that has one or more of its characteristics set or changed in such a manner as to encode information in the signal.

The computing device 512 includes input device(s) 524 such as keyboard, mouse, pen, voice input device, touch input device, infrared cameras, video input devices, or any other input device. Output device(s) 522 such as one or more displays, speakers, printers, or any other output device may be included with the computing device 512. Input device(s) 524 and output device(s) 522 may be connected to the computing device 512 via a wired connection, wireless connection, or any combination thereof. In one aspect, an input device or an output device from another computing device may be used as input device(s) 524 or output device(s) 522 for the computing device 512. The computing device 512 may include communication connection(s) 526 to facilitate communications with one or more other devices 530, such as through network 528, for example.

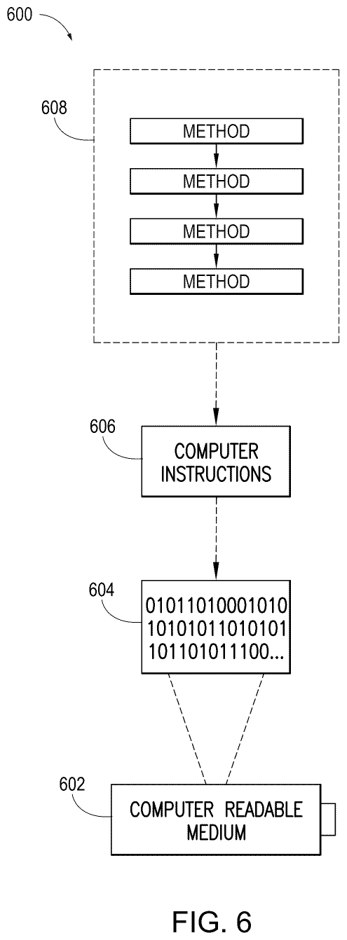

Still another aspect involves a computer-readable medium including processor-executable instructions configured to implement one aspect of the techniques presented herein. An aspect of a computer-readable medium or a computer-readable device devised in these ways is illustrated in FIG. 6, wherein an implementation 600 includes a computer-readable medium 602, such as a CD-R, DVD-R, flash drive, a platter of a hard disk drive, etc., on which is encoded computer-readable data 604. This encoded computer-readable data 604, such as binary data including a plurality of zero's and one's as shown in 604, in turn includes a set of processor-executable computer instructions 606 configured to operate according to one or more of the principles set forth herein. In this implementation 600, the processor-executable computer instructions 606 may be configured to perform a method 608, such as the computer-implemented method, algorithm 200, or algorithm 400 of FIG. 2 or FIG. 4. In another aspect, the processor-executable computer instructions 606 may be configured to implement a system, such as the system 100 for generating a generative trajectory model of FIG. 1. Many such computer-readable media may be devised by those of ordinary skill in the art that are configured to operate in accordance with the techniques presented herein.

As used in this application, the terms “component”, “module,” “system”, “interface”, and the like are generally intended to refer to a computer-related entity, either hardware, a combination of hardware and software, software, or software in execution. For example, a component may be, but is not limited to being, a process running on a processor, a processing unit, an object, an executable, a thread of execution, a program, or a computer. By way of illustration, both an application running on a controller and the controller may be a component. One or more components residing within a process or thread of execution and a component may be localized on one computer or distributed between two or more computers.

Further, the claimed subject matter is implemented as a method, apparatus, or article of manufacture using standard programming or engineering techniques to produce software, firmware, hardware, or any combination thereof to control a computer to implement the disclosed subject matter. The term “article of manufacture” as used herein is intended to encompass a computer program accessible from any computer-readable device, carrier, or media. Of course, many modifications may be made to this configuration without departing from the scope or spirit of the claimed subject matter.

Although the subject matter has been described in language specific to structural features or methodological acts, it is to be understood that the subject matter of the appended claims is not necessarily limited to the specific features or acts described above. Rather, the specific features and acts described above are disclosed as example aspects.

Various operations of aspects are provided herein. The order in which one or more or all of the operations are described should not be construed as to imply that these operations are necessarily order dependent. Alternative ordering will be appreciated based on this description. Further, not all operations may necessarily be present in each aspect provided herein.

As used in this application, “or” is intended to mean an inclusive “or” rather than an exclusive “or”. Further, an inclusive “or” may include any combination thereof (e.g., A, B, or any combination thereof). In addition, “a” and “an” as used in this application are generally construed to mean “one or more” unless specified otherwise or clear from context to be directed to a singular form. Additionally, at least one of A and B and/or the like generally means A or B or both A and B. Further, to the extent that “includes”, “having”, “has”, “with”, or variants thereof are used in either the detailed description or the claims, such terms are intended to be inclusive in a manner similar to the term “comprising”.

Further, unless specified otherwise, “first”, “second”, or the like are not intended to imply a temporal aspect, a spatial aspect, an ordering, etc. Rather, such terms are merely used as identifiers, names, etc. for features, elements, items, etc. For example, a first channel and a second channel generally correspond to channel A and channel B or two different or two identical channels or the same channel. Additionally, “comprising”, “comprises”, “including”, “includes”, or the like generally means comprising or including, but not limited to.

It will be appreciated that various of the above-disclosed and other features and functions, or alternatives or varieties thereof, may be desirably combined into many other different systems or applications. Also, that various presently unforeseen or unanticipated alternatives, modifications, variations, or improvements therein may be subsequently made by those skilled in the art which are also intended to be encompassed by the following claims.

1. A system for generating a generative trajectory model, comprising:
a memory storing one or more instructions; and
a processor executing one or more of the instructions stored on the memory to perform:
generating a non-interactive model that calculates probability distributions of predicted future trajectories for a first agent and a second agent based on a first portion of measured trajectory for each agent, wherein the non-interactive model assumes that each agent operates independently of one another;
generating a game-theoretic model that evaluates the probability distributions of predicted future trajectories based on a parameterized cost function and calculates a set of updated probability distributions of predicted future trajectories based on the evaluation; and
training a generative trajectory model that combines the non-interactive model and the game-theoretic model by:
calculating a training loss based on the set of updated probability distributions and a second portion of the measured trajectory for each agent; and
optimizing the parameterized cost function by minimizing the training loss through gradient descent.

2. The system of claim 1, wherein the non-interactive model utilizes a conditional variational autoencoder (CVAE) to generate the probability distributions of predicted future trajectories.

3. The system of claim 1, wherein the parameterized cost function comprises a deep neural network trained to represent an inter-agent interaction between the first agent and the second agent.

4. The system of claim 1, wherein the game-theoretic model uses a Bayesian recursive Nash equilibrium to calculate the set of updated probability distributions of predicted future trajectories.

5. The system of claim 4, wherein the Bayesian Recursive Nash Equilibrium iteratively updates sample weights of the predicted future trajectories to minimize expected costs between the first and second agents.

6. The system of claim 1, wherein the first agent is an ego-agent and the second agent is an adjacent agent operating adjacent to the ego-agent.

7. The system of claim 6, wherein the processor executes the one or more of the instructions stored on the memory to perform:
collecting real-time trajectories for the ego-agent and the adjacent agent from a sensor of the ego-agent;
calculating, by the non-interactive model, probability distributions of predicted future trajectories for the ego-agent and the adjacent agent based on the collected real-time trajectories;
calculating, by the game-theoretic model, a set of updated probability distributions of predicted future trajectory for the ego-agent by evaluating the probability distributions of predicted future trajectories for the ego-agent and the adjacent agent based on the parameterized cost function;
performing a path planning to generate a future trajectory for the ego-agent based on the set of updated probability distributions of predicted future trajectory; and
controlling the ego-agent to drive to a destination based on the generated future trajectory.

8. A computer-implemented method for generating a generative trajectory model, comprising:
generating a non-interactive model that calculates probability distributions of predicted future trajectories for a first agent and a second agent based on a first portion of measured trajectory for each agent, wherein the non-interactive model assumes that each agent operates independently of one another;
generating a game-theoretic model that evaluates the probability distributions of predicted future trajectories based on a parameterized cost function and calculates a set of updated probability distributions of predicted future trajectories based on the evaluation; and
training a generative trajectory model that combines the non-interactive model and the game-theoretic model by:
calculating a training loss based on the set of updated probability distributions and a second portion of the measured trajectory for each agent; and
optimizing the parameterized cost function by minimizing the training loss through gradient descent.

9. The computer-implemented method of claim 8, wherein the non-interactive model utilizes a conditional variational autoencoder (CVAE) to generate the probability distributions of predicted future trajectories.

10. The computer-implemented method of claim 8, wherein the parameterized cost function comprises a deep neural network trained to represent an inter-agent interaction between the first agent and the second agent.

11. The computer-implemented method of claim 8, wherein the game-theoretic model uses a Bayesian recursive Nash equilibrium to calculate the set of updated probability distributions of predicted future trajectories.

12. The computer-implemented method of claim 11, wherein the Bayesian Recursive Nash Equilibrium iteratively updates sample weights of the predicted future trajectories to minimize expected costs between the first and second agents.

13. The computer-implemented method of claim 8, wherein the first agent is an ego-agent and the second agent is an adjacent agent operating adjacent to the ego-agent.

14. The computer-implemented method of claim 13, comprising:
collecting real-time trajectories for the ego-agent and the adjacent agent from a sensor of the ego-agent;
calculating, by the non-interactive model, probability distributions of predicted future trajectories for the ego-agent and the adjacent agent based on the collected real-time trajectories;
calculating, by the game-theoretic model, a set of updated probability distributions of predicted future trajectory for the ego-agent by evaluating the probability distributions of predicted future trajectories for the ego-agent and the adjacent agent based on the parameterized cost function;
performing a path planning to generate a future trajectory for the ego-agent based on the set of updated probability distributions of predicted future trajectory; and
controlling the ego-agent to drive to a destination based on the generated future trajectory.

15. A non-transitory computer readable storage medium storing instructions that when executed by a computer having a processor to perform a method for generating a generative trajectory model, the method comprising:
generating a non-interactive model that calculates probability distributions of predicted future trajectories for a first agent and a second agent based on a first portion of measured trajectory for each agent, wherein the non-interactive model assumes that each agent operates independently of one another;
generating a game-theoretic model that evaluates the probability distributions of predicted future trajectories based on a parameterized cost function and calculates a set of updated probability distributions of predicted future trajectories based on the evaluation; and
training a generative trajectory model that combines the non-interactive model and the game-theoretic model by:
calculating a training loss based on the set of updated probability distributions and a second portion of the measured trajectory for each agent; and
optimizing the parameterized cost function by minimizing the training loss through gradient descent.

16. The non-transitory computer readable storage medium of claim 15, wherein the non-interactive model utilizes a conditional variational autoencoder (CVAE) to generate the probability distributions of predicted future trajectories.

17. The non-transitory computer readable storage medium of claim 15, wherein the parameterized cost function comprises a deep neural network trained to represent an inter-agent interaction between the first agent and the second agent.

18. The non-transitory computer readable storage medium of claim 15, wherein the game-theoretic model uses a Bayesian recursive Nash equilibrium to calculate the set of updated probability distributions of predicted future trajectories.

19. The non-transitory computer readable storage medium of claim 18, wherein the Bayesian Recursive Nash Equilibrium iteratively updates sample weights of the predicted future trajectories to minimize expected costs between the first and second agents.

20. The non-transitory computer readable storage medium of claim 15, the method comprising:
collecting real-time trajectories for an ego-agent and an adjacent agent from a sensor of the ego-agent;
calculating, by the non-interactive model, probability distributions of predicted future trajectories for the ego-agent and the adjacent agent based on the collected real-time trajectories;
calculating, by the game-theoretic model, a set of updated probability distributions of predicted future trajectory for the ego-agent by evaluating the probability distributions of predicted future trajectories for the ego-agent and the adjacent agent based on the parameterized cost function;
performing a path planning to generate a future trajectory for the ego-agent based on the set of updated probability distributions of predicted future trajectory; and
controlling the ego-agent to drive to a destination based on the generated future trajectory.
